(19) United States
(12) Patent Application Publication
(10) Pub. No.: US 2017/0301048 A1
(43) Pub. Date: Oct. 19, 2017

(54) CLOUD-BASED ESTATE MANAGEMENT AND EXECUTION

(71) Applicants: Simonetta Turek, Berkeley, CA (US); Sanjay Bonde, Menlo Park, CA (US); Lori Darinette Kendall, Columbus, OH (US)

(72) Inventors: Simonetta Turek, Berkeley, CA (US); Sanjay Bonde, Menlo Park, CA (US); Lori Darinette Kendall, Columbus, OH (US)

(21) Appl. No.: 15/468,081

(22) Filed: Mar. 23, 2017

Related U.S. Application Data
(60) Provisional application No. 62/312,459, filed on Mar. 23, 2016.

(51) Int. Cl. G06Q 50/18; G06Q 10/10

(52) U.S. Cl. CPC G06Q 50/186; G06Q 10/10

(57) ABSTRACT

A system for cloud-based estate management and execution is disclosed. With this system, digital representations of estate asset documents, estate transactions documents, are securely uploaded into an estate vault server where they are securely kept, accessible only by persons predesignated by the estate holder. Also stored within the system are information for those designated estate attorney and estate executor, and for persons designated by the estate holder to have interest in the estate. Upon death or other life changing event to the estate holder the system programmatically ensures that estate disposition proceeds in an orderly fashion, potentially through pre-designated workflows.

### CROSS-REFERENCE TO RELATED APPLICATIONS

This application claims priority to United States provisional patent application Ser. No. 62/312459, titled “CLOUD-BASED ESTATE MANAGEMENT AND EXECUTION” filed on Mar. 23, 2016. The disclosure of the above-referenced patent application is incorporated herein by reference in its entirety

### BACKGROUND OF THE INVENTION

### Field of the Art

The disclosure relates to the field of estate management, and more particularly to the field of creating an estate inventory, maintaining an estate, and transferring key information about the estate to the executor.

### Discussion of the State of the Art

In the field of estate management, individuals often manage their estate in a very passive or inconsistent manner. During life, the individual focuses on legal protection such as wills or trusts, including nominating an executor and beneficiaries, and focuses on generalized financial planning and decision around allocating assets, tax minimization planning, and other financial concerns. Upon passing or another major life event involving their estate (for example, a divorce or legal separation, or disability), the executor is then responsible for executing according to the expressed wishes in the will or trust, potentially including the estate holder's end-of-life wishes, managing and dispositioning property and assets according to the specification of the will or trust, as well as fiscal and legal responsibilities. There is generally a lack of up-to-date or consolidated information of personal assets or liabilities, and a comprehensive inventory is generally never created (or when it is, it is not updated and is incomplete). Additionally, there is a lack of available tools in the industry to help manage tasks and workflows that are a key part of an executor's responsibilities.

What is needed, is a system that consolidates an estate holder's information spanning personal data, digital accounts usernames and passwords, scanned copies of legal documents (such as the will or trust, property titles, etc.) information regarding assets, and liabilities and enables easy and continuous updates, forming a tool that assists an executor with workflows and process handling.

### SUMMARY OF THE INVENTION

Accordingly, the inventor has conceived and reduced to practice, in a preferred embodiment of the invention, a system and methods for cloud-based estate management and execution.

According to a preferred embodiment of the invention, a system for cloud-based estate management and execution has been developed comprising: an estate vault server stored in a memory of and operating on a processor of a computing device and configured to: receive and securely store estate instruments comprising at least estate asset records, and estate transaction records; receive and securely store configuration parameters comprising at least estate attorney designation data, and estate executor designation data; maintain the continued validity and accuracy of all entrusted estate instruments and designated estate agent contact data; monitor for occurrence of at least one preprogrammed life change event specific to an estate holder and perform specifically pre-programmed functions upon receipt of notification that one of said life change events has occurred; present programmatically pre-designated estate instruments to at least one pre-designated party in conjunction with any available pre-constructed workflows specific for one of more tracked life change events comprising steps to properly act upon the estate holder's intentions in event of tracked life change event occurrence; send programmatic commands to a notification server when at least a tracked life change event or need for estate instrument modification is needed; and a notification server stored in a memory of and operating on a processor of a computing device and configured to: maintain a current list of parties with interest in an estate's assets; programmatically perform contact and message initialization, continuation and tracking in event of estate instrument modification requirement or occurrence of a tracked life change event to ensure that each transaction completes with a pre-designated successful result is disclosed.

According to another preferred embodiment of the invention, a method for cloud-based estate management the steps comprising: a) receiving and securely storing estate instruments comprising at least estate asset records, and estate transaction records at an estate vault server stored in a memory of and operating on a processor of a computing device; b) receiving and securely storing configuration parameters comprising at least estate attorney designation data, and estate executor designation data at the estate vault server; c) maintaining the continued validity and accuracy of all entrusted estate instruments and designated estate agent contact data using the estate vault server; d) monitoring for occurrence of at least one preprogrammed life change event specific to an estate holder and perform specifically pre-programmed functions upon receipt of notification that one of said life change events has occurred using the estate vault server; e) presenting programmatically pre-designated estate instruments to at least one pre-designated party in conjunction with any available pre-constructed workflows specific for one of more tracked life change events comprising steps to properly act upon the estate holder's intentions in event of tracked life change event occurrence using the estate vault server; f) sending programmatic commands to a notification server when at least a tracked life change event or need for estate instrument modification is needed from the estate vault server; g) maintaining a current list of parties with interest in an estate's assets using a notification server stored in a memory of and operating on a processor of a computing device; h) performing contact and message initialization, continuation and tracking in event of estate instrument modification requirement or occurrence of a tracked life change event to ensure that each transaction completes with a pre-designated successful result is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary system architecture for cloud-based estate management and execution, according to a preferred embodiment of the invention.

FIG. 6 is a flow diagram illustrating an exemplary method for cloud-based estate management, according to a preferred embodiment of the invention.

FIG. 7 is a flow diagram illustrating an exemplary method for cloud-based estate execution, according to a preferred embodiment of the invention.

FIG. 8 is a flow diagram illustrating an exemplary method for handling a potential life event, according to a preferred embodiment of the invention.

### DETAILED DESCRIPTION

The inventor has conceived, and reduced to practice, in a preferred embodiment of the invention, a system and methods for cloud-based estate management and execution.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, the underlying mechanism can also be demonstrated with a single device or article may be used as a demonstration of multiple device or articles. This is done for the sake of brevity and parsimony, as n+1 relationships are envisioned in this architecture.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

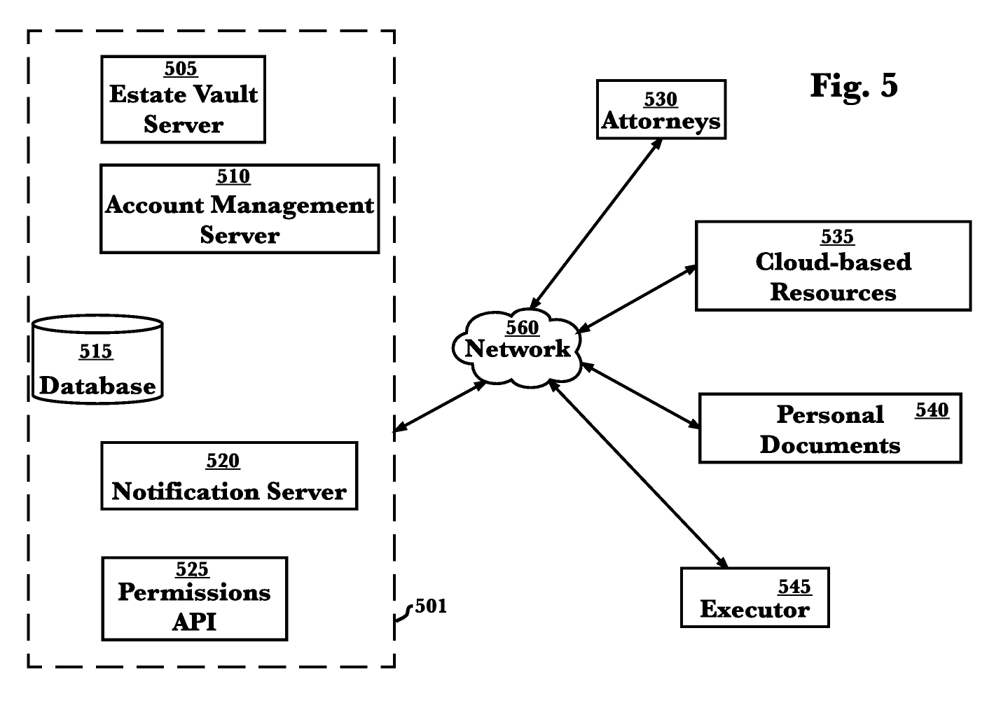

FIG. 5 is a block diagram illustrating an exemplary system architecture for cloud-based 560 estate management and execution, according to a preferred embodiment of the invention. According to the embodiment, a cloud-based estate management system 501 may comprise an estate vault server 505 that manages documents and processes, such as storing inventory items and personal documents 540 received from an estate holder, documents provided by attorneys 530 or an executor 545, management processes and workflows for the executor, or information received from various third-party services or products such as cloud-based 560 estate management resources (for example, ESTATEEXEC™ or other products or services) 535. An account management server 510 may manage user accounts, for example to maintain accounts for various members of an estate holder's family, an executor 545, attorneys 530, or other interested parties that may need to be able to provide or view various information pertaining to an estate. A notification server 520 may generate and transmit notifications to attorneys 530, an executor 545, the estate holder, or other interested parties as needed, for example to prompt an estate holder to update information or to notify an attorney 530 or executor 545 of changes. A permissions API 525 may be used to enforce permissions boundaries, ensuring that interested parties are given access to the information they need but may not view restricted information (for example, preventing anyone but the estate holder, executor, or selected attorneys from viewing the detailed contents of a living will).

According to the embodiment, an estate holder may provide information and store documents throughout their life, and may establish accounts for various interested parties to whom they wish to provide access to some or all of the information contained in their estate vault 501. This may be used to (for example) restrict access for selected third-party products or services to ensure they may only modify information they have submitted (preventing one service from seeing or altering data from another, for example), or to enable selected attorneys 530 to provide information in a one-way manner, having access to submit information pertinent to the estate but not to view or modify any information (for example, so that an attorney 530 may submit files related to a specific legal case that may be relevant to the estate, but who may have no interest in the estate otherwise). Configured accounts may also comprise instructions or configurations for handling permissions and other concerns upon a qualifying life event, such as bankruptcy, divorce, or death (or any other life event that could potentially involve or affect the estate). An additional feature of configured accounts and permissions may be configured local authorities, agencies, or other parties that may be referenced as needed, for example to notify of a life event or to request specific authorities as needed for execution of an estate. Attorneys 530 may optionally be configured according to a ranked system, for example to determine an order in which to contact specific attorneys 530 or in which to request assistance (for example, a ranked list of preferred estate attorneys for assisting with the estate's execution).

Additionally, an estate management server 505 may perform automated document or file recognition on submitted data, for example to assist an estate holder or interested party in categorizing data as it is provided and thereby reducing digital clutter and contributing toward overall information organization. For example, scanned documents may be analyzed (for example using optical character recognition or metadata tags) to determine categorization information such as “vehicle title” or “house maintenance receipt”. These documents may then be automatically sorted into their appropriate categories based on analysis, optionally after allowing the submitting user or an estate holder to review and correct as needed. Automatic classification may be further enhanced via integration with third-party products or services as described previously, such as integration with certain tax or insurance systems for easier and more precise classification of associated documents or files.

An extended example of automated recognition may include the use of machine learning to process an estate holder's personal accounts, optionally before or after a qualifying event, such as to identify potential items of interest. For example, during life an estate holder may be proactively prompted to add information based on documents received in a configured email account. After death, an estate holder's accounts or other assets may be processed to identify any additional items or information of interest that may have been forgotten or omitted, such as financial transactions that were not reported to an estate management system 501 or personal records that were kept hidden from other parties (such as records of a medical condition prior to death, for example). Another use may be to automatically identify potential assets for handling, and optionally to reconcile them with a static or ongoing estimate of net worth for use during estate handling. These functionalities may be enhanced through the use of a rules engine, as described below.

A further exemplary automated operation that may be performed on data submitted, may be automated calculation of net worth (or fine-grained valuations, such as property appraisals or estimates). For example, an estate holder may provide documents for valuable property and these documents may be analyzed to determine the value of said property. This value may then be associated with the property record and optionally added to an estimated net worth for the estate overall.

A database 515 may be used to securely store documents and information and to provide information as needed for use or review. Information may be encrypted and encryption keys may be managed by an account management server to enable access to various information for various parties, and various methods of securing information may be utilized as needed or according to an estate holder's preference, such as including (for example, and not limited to) a block chain database structure that maintains a continuous list of transactions or modifications and is protected against tampering.

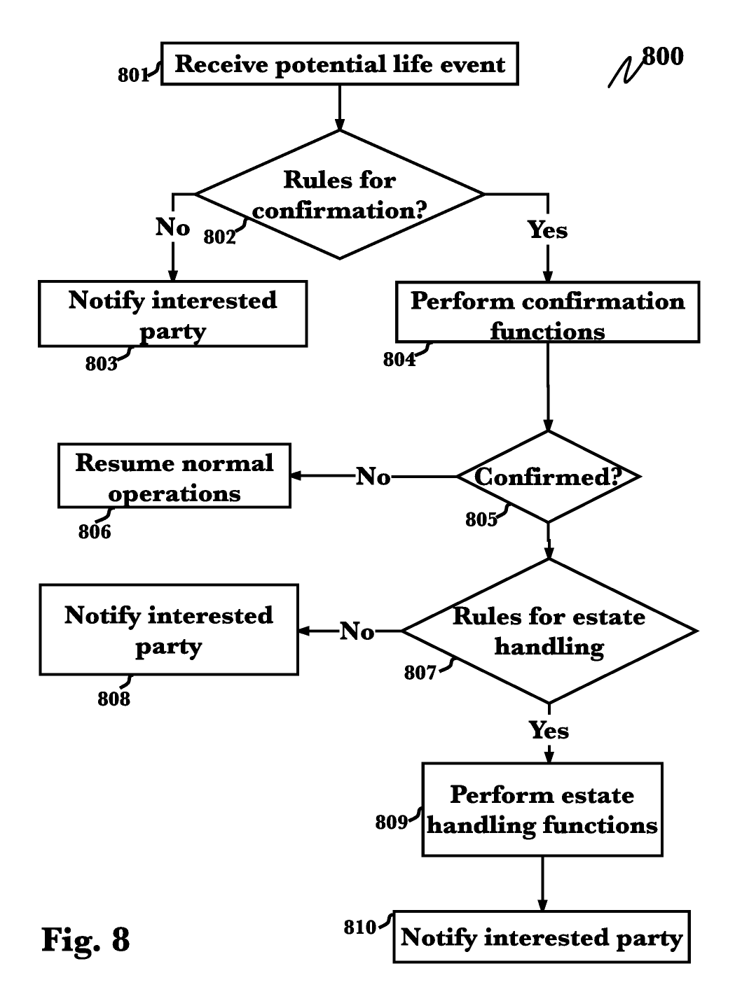

A rules engine may be used to configure and enforce various operation rules such as (for example) to perform specified actions on specific information or to automatically obfuscate sensitive or irrelevant information as appropriate. For example, an estate holder may have personal documents they do not wish to come to light, that may be obfuscated or destroyed upon their passing before an estate executor or anyone else can obtain them (or even be made aware of their presence). Another example may be to automatically lock an estate holder's personal accounts, whether financial accounts or user logins for online products or services, or any other configured login or account holder information. For example, upon a potential life event, the system may proactively change or scramble the user's passwords to various social media accounts, preventing access by any unauthorized parties who may have been provided their login information in the past, and may then store the new passwords for future reference. Upon further event handling, the new passwords may be provided to interested parties according to configured rules, for example they may be provided to the estate holder after confirming the event was a “false alarm”, allowing them to reconfigure their accounts for regular use, or selected account information may be provided to an executor 545 for handling as they perform their duties. This functionality may be further enhanced through the use of a password or account manager as described below, such as to store large numbers of login information in a convenient way (for an estate holder during normal activities) and also for storing the new, “locked-down” account details as needed without the risk of losing account access altogether. Additionally, a “heartbeat” system may be utilized, that may check regularly for an estate holder's activity such as by manually responding to configured notifications to effectively create a “dead man” switch, wherein failure to respond to a notification or notifications (or failure to do so within a timely manner) may trigger system operations and be treated as a potential life event (as described below in FIG. 8). Another use may be a per-device electronic monitor, that may run as a background process or service on a computer or mobile device and may be used to check status or receive notifications as well as to perform per-device actions as needed, such as (for example) to lock the device and prevent access in response to a potential life event, or to access, obfuscate, or destroy information on the device according to configured rules.

It may be appreciated that security and privacy may be a large concern when handling such sensitive information as an estate holder's detailed personal and property information, both to protect against theft or tampering from malicious parties as well as to protect estate contents from government entities (for example, that may have an interest in seizing assets). Additionally, an estate management system 501 may be configured to assist with an estate holder's digital identity, storing or managing online accounts, login information (for example, either by storing account passwords and permissions or instructions for their handling, or storing a “master password” for an external password or account management system such as LASTPASS™ or 1PASSWORD™), virtual property holdings (for example, money tied up in cryptocurrencies or virtual goods), and may be configured to assist in appropriately dealing with these assets and accounts when needed. For example, many academics may have a strong “online presence”, that is part of a digital identity and may be kept distinct from their legal or physical identity (for example, such as prominent bloggers, hosts of online or other broadcast programs, or creators of digital content). These assets and identities may still be considered part of an estate and may be factored into estate proceedings, and their information may be securely handled and processed by an estate management system based on user configuration (that is, the configuration of digital identity information need not be mandatory to utilize other functions and benefits of an estate management system, but are available for users who wish to utilize them). Another example may be intangible assets associated with an estate holder, such as (for example) a writer's characters or other intellectual property (IP). These are still assets belonging to the estate, though they may be difficult to handle in a tangible sense. Information and documentation pertaining to such intangible assets (for example, copyright or trademark documents providing a legal backing for IP assets) may be stored and updated along with other, more tangible assets within an estate management system. In some cases, external products or services may require personal identification to handle digital assets, such as account access for a utility or software provider. In such instances, instructions or contact information may be stored for provision when needed, for example to direct an executor to a preferred attorney for obtaining a court order to “unlock” account information with a third party.

It may be appreciated that an account with an estate management system 501 is itself an asset belonging to an estate, and in some arrangements specific instructions or other information may be associated with the account in a public or “semi-privileged” context, for example to declare selected interested parties as being permitted access to some or all of an estate management account. Such information may be associated with notifications as described below (for example, to notify specific parties that their action is needed on an estate management account), or with configured permissions and accounts as described previously (for example, to specify selected parties that are permitted to access portions of the estate management account, as well as what their permissions and duties are regarding assets within the account once accessed).

Notifications 520 may be produced and sent to various parties to inform them of various events, such as changes in estate information, important life events, or to prompt for new information such as for periodic updates. For example, an estate holder may be prompted on a regular basis to update and provide information, to ensure that an estate vault remains current. An attorney may be notified of important life events that may affect the estate or other interested parties, such as health concerns or changes of residence (as new local laws may affect the management of an estate). An executor 545 may be notified of important life events so that they may correspond with the estate holder and stay informed, as well as to update their own information as needed (such as contact information for the executor, or conflicts with their own estate or life events.

After a qualifying life event (for example, such as a divorce, bankruptcy filing, death, or other major event involving the estate), the estate vault server 505 may provide a number of functions, processes, and workflows to assist attorneys 530 and an executor 545 in the management and execution of the estate. For example, document preparation may be handled via templates, various estate assets may be automatically transferred to their respective parties as needed, checklists and workflows may be provided for specific estate execution operations, and various software integrations may be provided such as for various third-party accounting or legal tools, to ease the estate execution process.

### Detailed Description of Exemplary Embodiments

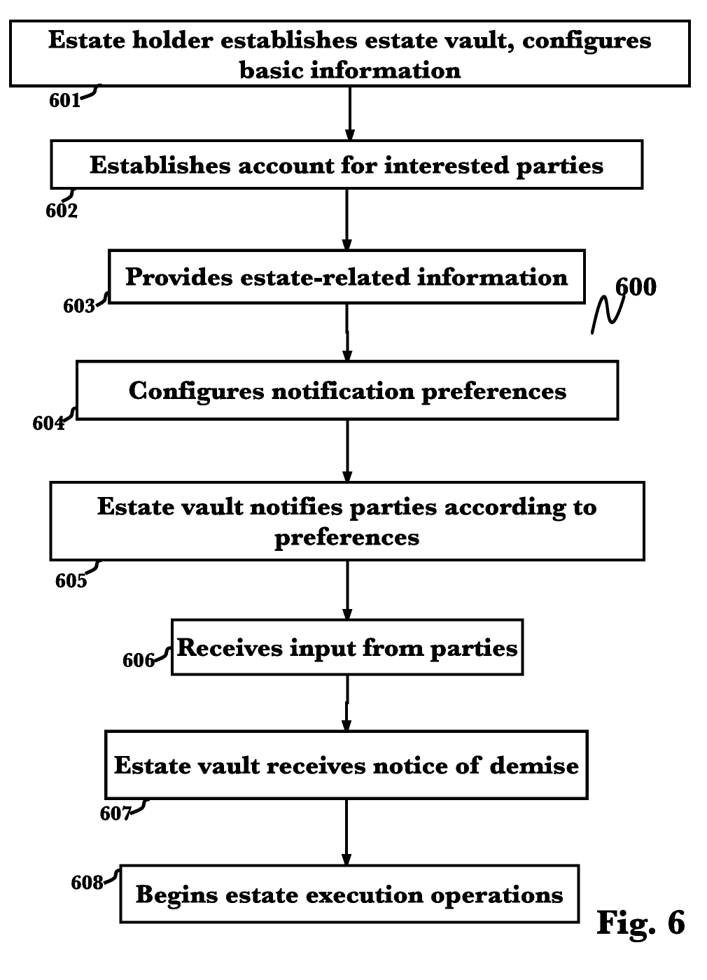

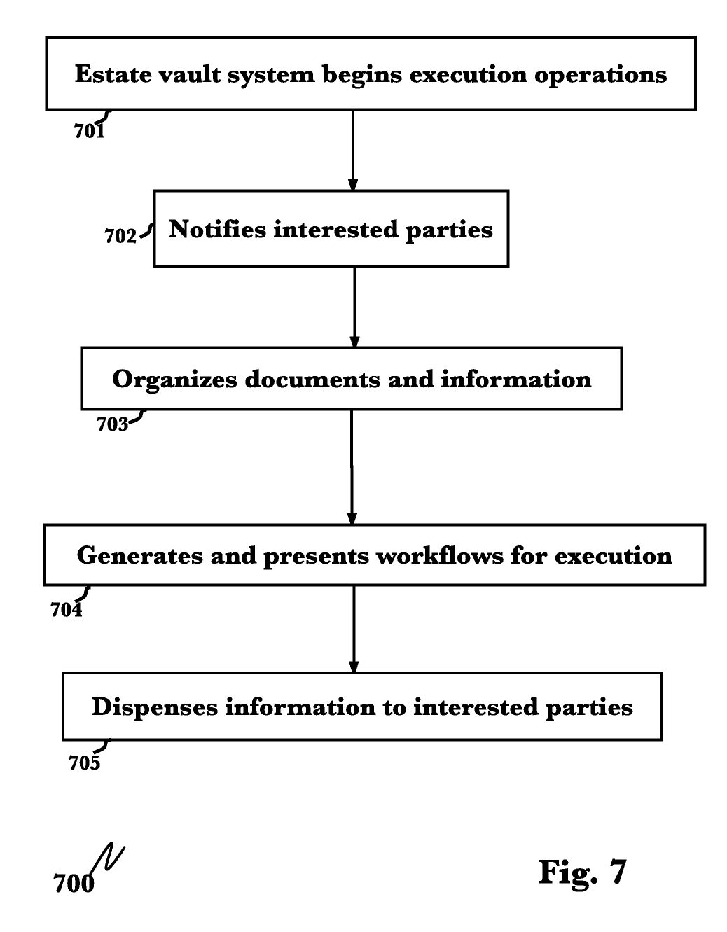

FIG. 6 is a flow diagram illustrating an exemplary method for cloud-based estate management 600, according to a preferred embodiment of the invention. In an initial step, an estate holder may establish an account with an estate vault system, setting up basic information such as their personal and contact details, names of interested parties, and other basic account profile information 601. In a next step the estate holder may establish accounts for interested parties, such as nominating an executor and providing information for attorneys, for example contact details or permissions preferences (such as granting “view all” access or “read/write this” access to various parties, as desired) 602. The estate holder may then provide estate-specific information such as inventories of items, legal or personal documents, or other details pertaining to the estate itself 603. The estate holder may then also configure notification preferences for interested parties, such as selecting a notification interval for the estate vault to prompt them to update information, or to select notification preferences such as contact details or trigger conditions (for example, “notify executor immediately via this email address if I have a medical emergency”) 604. Over time, the estate vault may provide notifications to interested parties based at least in part on the notification configuration from a previous step 605, and may receive input from parties such as response to notifications or new documents or information related to the estate 606. Upon the death of the estate holder, the estate vault system may be notified (for example, via a preconfigured attorney that may have been configured in a previous step) 607, and may then begin estate execution operations (as described below, referring to FIG. 7) 608.

FIG. 7 is a flow diagram illustrating an exemplary method for cloud-based estate execution 700, according to a preferred embodiment of the invention. Upon demise of an estate holder, an estate vault system may begin execution operations 701, initially by notifying interested parties of the event (for example attorneys and an executor so that they may then begin execution of the estate) 702. The estate vault may then automatically organize information and documents, for example grouping documents according to their respective interested parties (such as legal files for an attorney), collecting information from various sources and sorting various files and information for easier processing by an executor, or other organization operations 703. In a next step, the estate vault may generate and present a number of workflows, checklists, or other aids optionally based at least in part on the results of information organization 704, and in a final step may dispense various information to interested parties as appropriate 705. For example, grouped legal documents and associated resources may be provided to an attorney for processing, notifications regarding the estate may be provided to various interested parties such as family members, and workflows and relevant information may be automatically provided to an executor to assist them in their duties.

FIG. 8 is a flow diagram illustrating an exemplary method for handling a potential life event 800, according to a preferred embodiment of the invention. According to the embodiment, an estate vault server may receive a notification of a potential life event 801, such as (for example) if an estate holder fails to respond to notifications in a timely manner, or if a registered party provides explicit notification of an event (such as if a family member notifies the system that someone has died). The event that follows depends on whether explicit rules for confirmation have been configured within the embodiment 802. If no confirmation rules have been configured, the embodiment may notify one or a plurality of parties with some type of interest in the disposition of the estate such as emergency personnel, a designated attorney or the executor of the estate 803. If entered certain family members, close friends and other who have no direct interest in the estate but have personal relationships with the estate holder may also be notified 803. If one of more rules for confirmation of a life event are in effect, preprogrammed functions to confirm the validity of the possible life event will be activated 804. If the confirmation functions fail to confirm that the life event has transpired 805, normal operation of the embodiment will resume 806. If the life event is confirmed 805 and no estate handling rules for the confirmed event are present 807, parties predesignated to be notified with regards to estate handling under conditions that the confirmed life event has occurred may be notified 808. If specific estate handling rules exist 807, actions specified by those rules such as online account securing, and obfuscation or destruction of designated personal information among other possible activities known to those skilled in the art may be taken 809 before parties interested in the disposition of the estate are notified 810.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

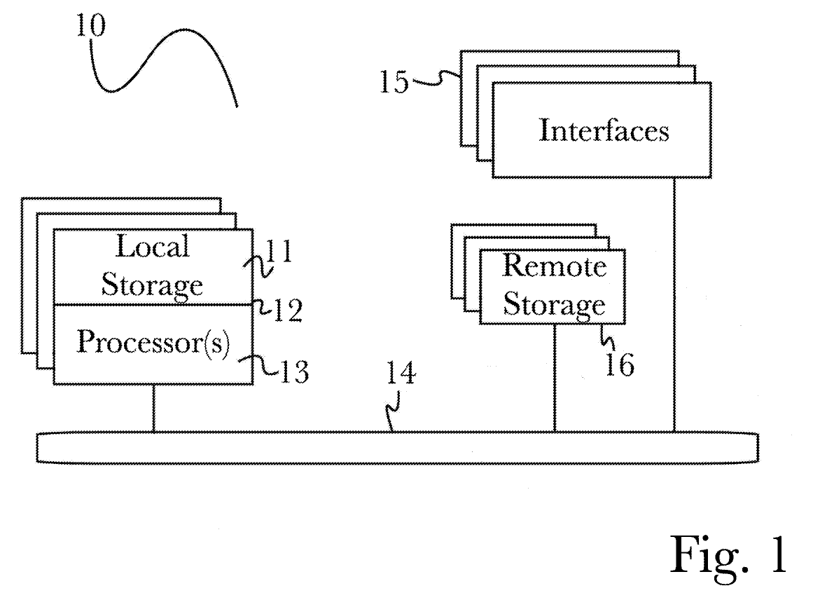

Referring now to FIG. 1, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory.

Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories

(EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™ , THUNDERBOLT™ , PCI, parallel, radio frequency (RF), BLUETOOTH™ , near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface

(HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

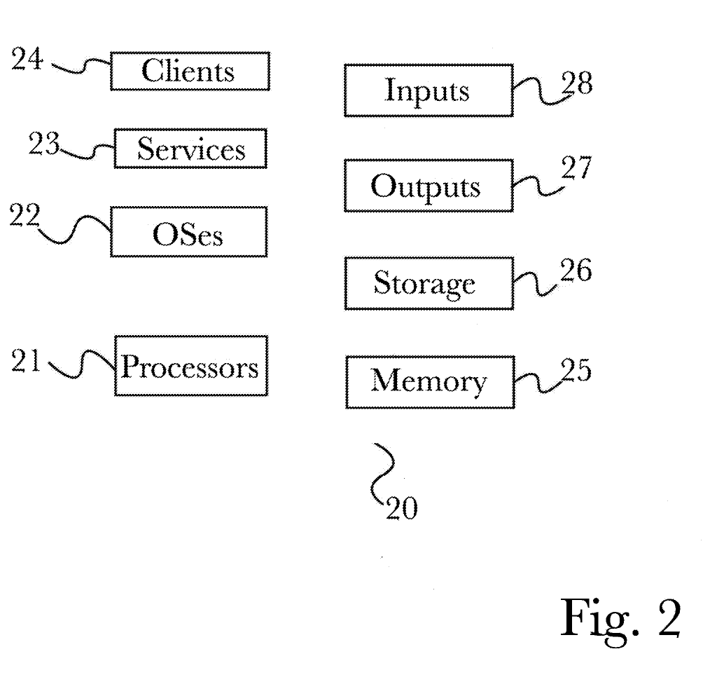

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 1). Examples of storage devices 26 include flash memory, magnetic hard drive, CD-ROM, and/or the like.

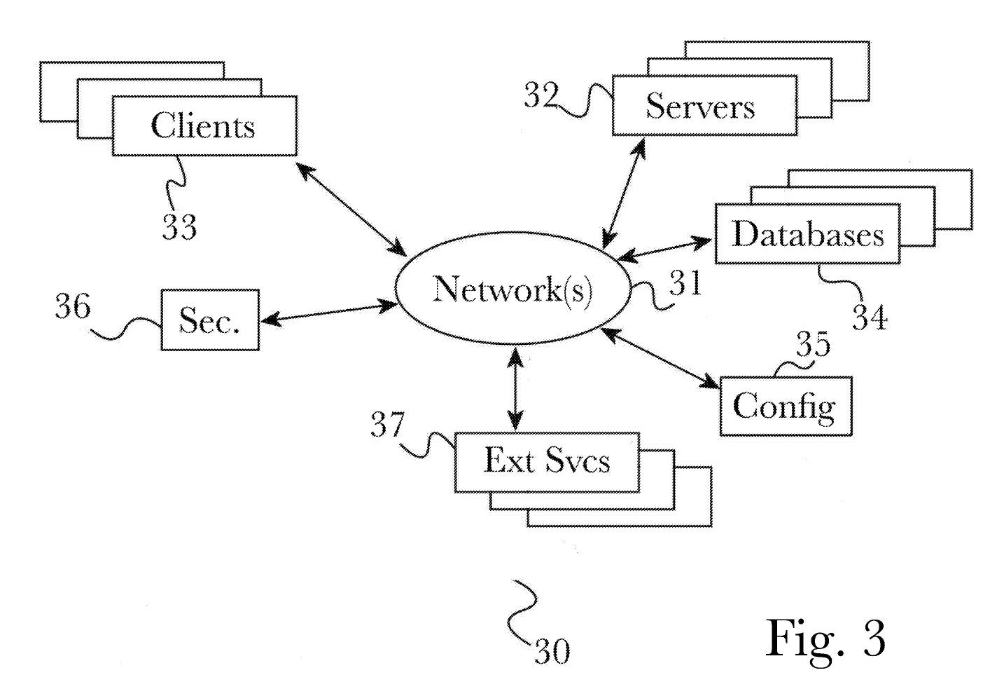

In some embodiments, systems of the present invention may be implemented on a distributed computing network, such as one having any number of clients and/or servers. Referring now to FIG. 3, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 2. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™ , GOOGLE BIGTABLE™ , and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

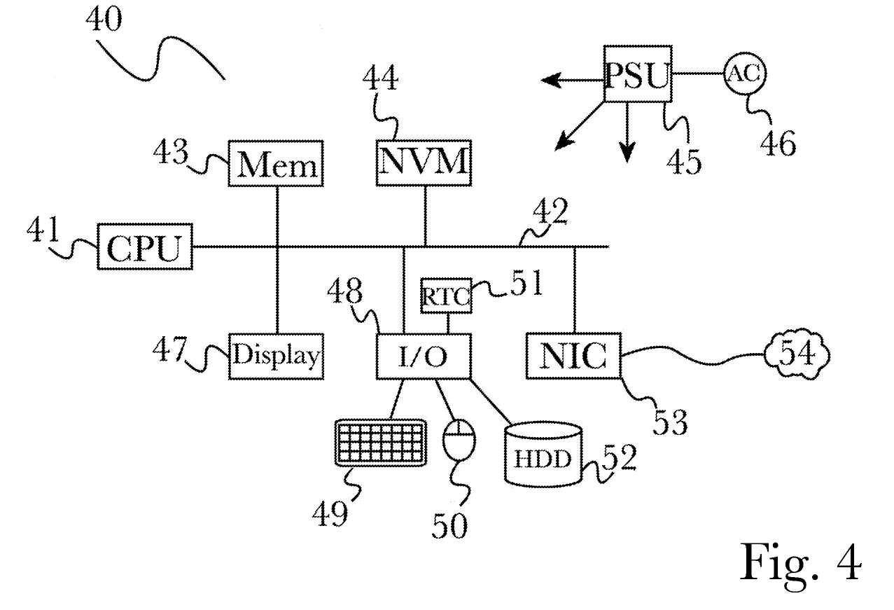

FIG. 4 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed:

1. A system for cloud-based estate management and execution comprising:
an estate vault server stored in a memory of and operating on a processor of a computing device and configured to:
receive and securely store estate instruments comprising at least estate asset records, and estate transaction records;
receive and securely store configuration parameters comprising at least estate attorney designation data, and estate executor designation data;
maintain the continued validity and accuracy of all entrusted estate instruments and designated estate agent contact data;
monitor for occurrence of at least one preprogrammed life change event specific to an estate holder and perform specifically pre-programmed functions upon receipt of notification that one of said life change events has occurred;
present programmatically pre-designated estate instruments to at least one pre-designated party in conjunction with any available pre-constructed workflows specific for one of more tracked life change events comprising steps to properly act upon the estate holder's intentions in event of tracked life change event occurrence;
send programmatic commands to a notification server when at least a tracked life change event or need for estate instrument modification is needed; and
a notification server stored in a memory of and operating on a processor of a computing device and configured to:
maintain a current list of parties with interest in an estate's assets;
programmatically perform contact and message initialization, continuation and tracking in event of estate instrument modification requirement or occurrence of a tracked life change event to ensure that each transaction completes with a pre-designated successful result.

2. A method for cloud-based estate management and execution, the steps comprising:
a) receiving and securely storing estate instruments comprising at least estate asset records, and estate transaction records at an estate vault server stored in a memory of and operating on a processor of a computing device;
b) receiving and securely storing configuration parameters comprising at least estate attorney designation data, and estate executor designation data at the estate vault server;
c) maintaining the continued validity and accuracy of all entrusted estate instruments and designated estate agent contact data using the estate vault server;
d) monitoring for occurrence of at least one preprogrammed life change event specific to an estate holder and perform specifically pre-programmed functions upon receipt of notification that one of said life change events has occurred using the estate vault server;
e) presenting programmatically pre-designated estate instruments to at least one pre-designated party in conjunction with any available pre-constructed workflows specific for one of more tracked life change events comprising steps to properly act upon the estate holder's intentions in event of tracked life change event occurrence using the estate vault server;
f) sending programmatic commands to a notification server when at least a tracked life change event or need for estate instrument modification is needed from the estate vault server;
g) maintaining a current list of parties with interest in an estate's assets using a notification server stored in a memory of and operating on a processor of a computing device;
h) performing contact and message initialization, continuation and tracking in event of estate instrument modification requirement or occurrence of a tracked life change event to ensure that each transaction completes with a pre-designated successful result.
